(19) United States
(12) Patent Application Publication
(10) Pub. No.: US 2004/0131419 A1
(43) Pub. Date: Jul. 8, 2004

(54) Articulating spline

(75) Inventor: Brian L. Hammond, Kuna, ID (US)

Correspondence Address: DYKAS, SHAVER & NIPPER, LLP, P.O. BOX 877, 802 WEST BANNOCK STREET, SUITE 405, BOISE, ID, 83701, US

(73) Assignee: Multiquip, Inc., Carson, CA

(21) Appl. No.: 10/336,282

(22) Filed: Jan. 3, 2003

(51) Int. Cl. F16B 12/36

(52) U.S. Cl. 403/298

(57) ABSTRACT

An improved roller screed utilizing an articulated roller screed spline for allowing for the creation of crowns and trenches in widths of poured and finished concrete. The spline being generally prolate in shape.

### BACKGROUND OF THE INVENTION

1. Field of the Invention

The present invention generally relates to roller screeds, and more particularly relates to methods and apparatuses for creating a convex or concave finish to the surface screeded through utilizing such a roller screed.

2. Background Information

Roller screeds comprise a frame having a power driven roller, typically comprising a number of joined strike tubes, that is moved across a freshly poured concrete surface thereby rolling said concrete surface into a flat, smooth finish. Typically, such a power screed would utilize a plurality of sections or modules whereby the power screed can be configured to have a desired length. Typical lengths of such modules are three, four, five, six, eight, and nine feet. However, utilizing such a modular construction easily allows for screed lengths exceeding fifty feet.

A typical roller screed is shown in U.S. Pat. No. 5,664,908 to Paladeni. Referring to FIG. 3 of Paladeni, a typical pair of screed modules is joined at a plate (62). Each of these modules having a roller or strike tube that is connected together through the use of a generally cylindrical spline (100). Power screws (66) and collars (68) are utilized to adjust the pitch of the two panels towards one another by drawing the dorsal side of the panel or panels nearer or farther from the plate (62). Through adjusting these screws within these collars, as Paladeni describes it, “ . . . the rotary screed 10 can be configured for long lengths because any sag that occurs in which the medial ends 80 of the strike tubes dip below the distal ends 82 can be adjusted by turning the power screws 66.” (col. 4, In. 22-25).

The intended use of power screeds is to create extremely flat concrete surfaces. Paladeni discloses a device that is able to be adjusted to maintain the screed thereby allowing for a consistent, flat surface. However, it can also be desirable to create a concrete surface which is intentionally not flat. For instance, a user might desire to utilize these module sections to create varying degrees of slight, gradual pitch between one or more of the junctions between adjoining modules.

For instance, take a power screed having a pair of joining modules. These modules each having first ends which extend to second ends. These first ends joining at a junction. The second ends resting upon a rail or frame which contacts the ground surface. Thus, by raising the junction relative to the second ends, a convex surface will be created in the resulting concrete surface. Such a peak would be useful for causing water to roll off the concrete surface. Likewise, lowering the juncture relative to the second ends will create a concave surface. Such a concave surface is useful for collecting water in a trough.

It is known in the prior art to take such power screws and collars and tightening or loosing them to result in a very slight or gradual pitch being occurred in either a concave or convex surface resulting from the use of the roller tubes of the present invention. Such usage, while beneficial to the user, is not recommended by the manufacturer for the reason that application of such torque upon the spline greatly increases wear to the spline and associated assembly. This wear likewise causing an increased rate of failure of the spline assembly.

What is needed is a method of allowing for the creation of crowns or trenches in concrete surfaces whereby the spline is not placed in a position of damage. The present invention solves this need.

Additional objects, advantages and novel features of the invention will be set forth in part in the description which follows and in part will become apparent to those skilled in the art upon examination of the following or may be learned by practice of the invention. The objects and advantages of the invention may be realized and attained by means of the instrumentalities and combinations particularly pointed out in the appended claims.

### SUMMARY OF THE INVENTION

The present invention is a method of and apparatus for creating upwards or downwards pitch in a roller screed and the apparatuses necessary to implement the same.

One embodiment of the present invention comprises an articulating rotary spline for joining a first roller to a second roller so that rotation of the first roller or the second roller results in rotation of the other roller. This spline comprising an elongated shaft having a first end extending to a second end. This shaft defining a first portion, a central portion, and second portion. A first annular groove is defined in the shaft between the central portion and the first portion. The first portion being generally prolate (cigar-shaped) in shape between the first end and the first annular groove. A plurality of longitudinal gear teeth are located on the spline first portion for interfitting relationship with corresponding longitudinal gear teeth within the first roller. Likewise, longitudinal gear teeth are located on the spline second portion for interfitting relationship with corresponding longitudinal gear teeth within the second roller.

Another embodiment of the present invention comprises an articulating rotary spline for joining a first roller to a second roller so that rotation of the first roller or the second roller results in rotation of the other roller. This spline comprising an elongated shaft having a first end extending to a second end. This shaft defines a first portion, a central portion, and a second portion. A first annular groove is defined in the shaft between the central portion and the first portion. A second annular groove is defined in the shaft between the central portion and the second portion. The first portion generally prolate in shape between the first end and the first annular groove. The second portion generally prolate in shape between the second end and the second annular groove. Longitudinal gear teeth are located on the spline first portion for interfitting relationship with corresponding longitudinal gear teeth within the first roller. Longitudinal gear teeth are located on the spline second portion for interfitting relationship with corresponding longitudinal gear teeth within the second roller.

Another embodiment of the present invention comprises an articulating rotary spline for joining a first roller to a second roller so that rotation of the first roller or the second roller results in rotation of the other roller. This spline comprising an elongated shaft having a first end extending to a second end. This shaft defining a first portion, a central portion, and a second portion. A first annular groove is defined in the shaft between the central portion and the first portion. A second annular groove is defined in the shaft between the central portion and the second portion. The first portion having a circumvolving first crest between the first annular groove and the first end. This first crest having a diameter greater than the first annular groove. The first crest having a diameter greater than the first end, wherein the first portion circumvolvingly tapers from the first annular grove to the first crest and the first portion circumvolvingly tapers from the first crest to the first end. The second portion having a circumvolving second crest between the second annular groove and the second end. This second crest having a diameter greater than the second annular groove. The second crest having a diameter greater than the second end, wherein the second portion circumvolvingly tapers from the second annular grove to the second crest and the second portion circumvolvingly tapers from the second crest to the second end. Longitudinal gear teeth are located on the spline first portion for interfitting relationship with corresponding longitudinal gear teeth within the first roller. Longitudinal gear teeth are also located on the spline second portion for interfitting relationship with corresponding longitudinal gear teeth within the second roller.

Still other objects and advantages of the present invention will become readily apparent to those skilled in this art from the following detailed description wherein I have shown and described only the preferred embodiment of the invention, simply by way of illustration of the best mode contemplated by carrying out my invention. As will be realized, the invention is capable of modification in various obvious respects all without departing from the invention. Accordingly, the drawings and description of the preferred embodiment are to be regarded as illustrative in nature, and not as restrictive.

### BRIEF DESCRIPTION OF THE DRAWINGS

FIG. 1 is a side view of one embodiment of a power screed utilizing the present invention.

FIG. 2 is a partial, cut-away, side view of the embodiment of FIG. 1.

FIG. 3 is a side view of one embodiment of a spine utilized in the present invention.

FIG. 4 is an end view of FIG. 3.

FIG. 5 is a partial, cross-sectional view of the embodiment of FIG. 3.

FIG. 6 is a partial, cut-away, side view of the embodiment of FIG. 1 showing the configuration of the present invention to create a trough in the surface finished.

FIG. 7 is a partial, cut-away, side view of the embodiment of FIG. 1 showing the configuration of the present invention to create a ridge in the surface finished.

### DESCRIPTION OF THE PREFERRED EMBODIMENTS

While the invention is susceptible of various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

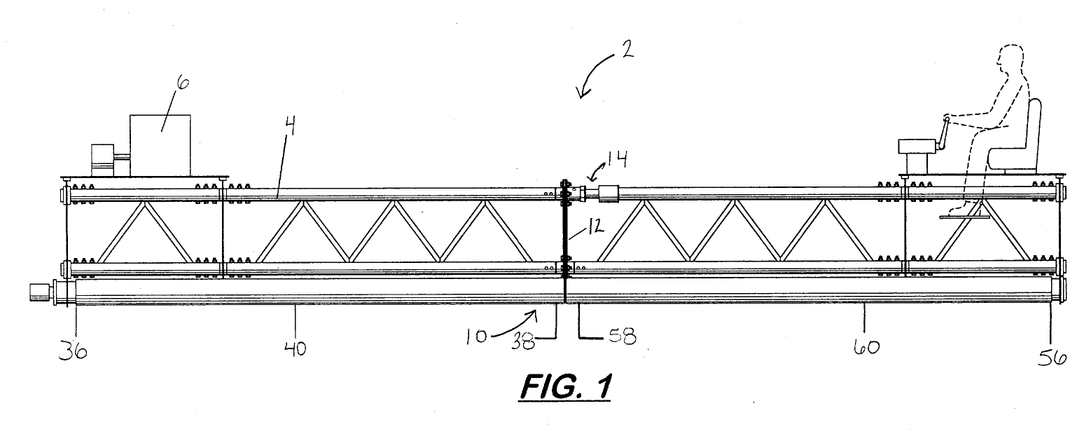

Referring initially to FIG. 1, shown is one general embodiment of a roller screed 2. The present invention is particularly considered relevant with respect to roller screeds, but could be utilized in any situation where two rotating shafts, tubes, rods, rollers, columns, pillars, poles, parts, portions, etc. are joined together. The general term “roller screed” is intended to include all of these other situations. A typical “roller screed” has a drive means 6, such as an engine or a motor, for driving the rotation of one or more strike tubes 40, 60. These strike tubes suspended below a roller screed frame 4.

The roller screed frame 4, in the embodiment shown, has a pair of strike tubes 40, 60 that join together at a middle bracket 12. At least one elevation adjustment 14 is utilized to adjust the pitch of the two strike tubes relative to one another and/or in relation to the middle bracket. The first strike tube 40 has a first end 36 extending to a second end 38. The second strike tube 60 has a first end 56 extending to a second end 58. The invented pitch controller 10 is utilized to rotationally join the strike tube second ends 38, 58 together.

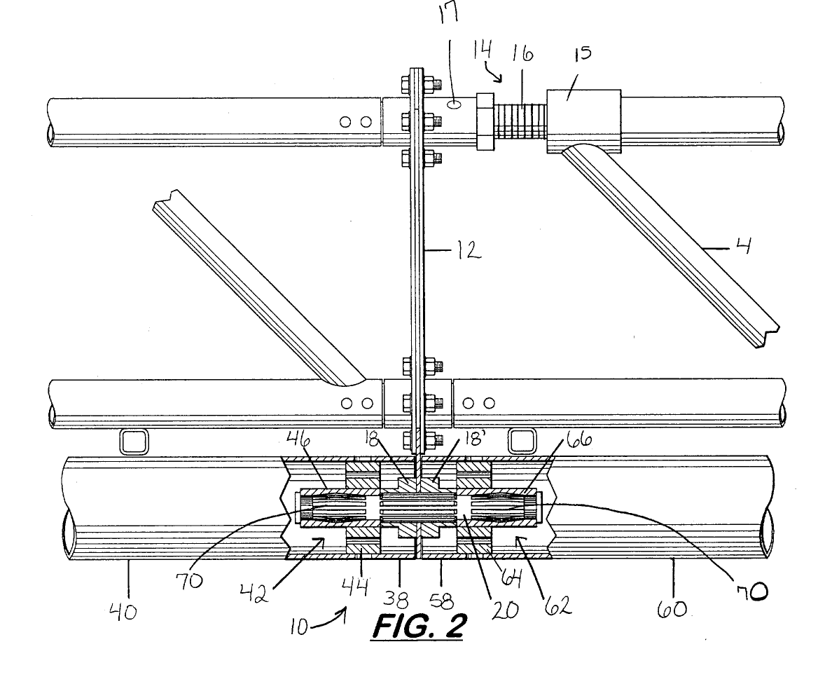

Referring now to FIG. 2, the embodiment of FIG. 1 is shown in partial detail. The present invention is a pitch controller 10 for raising or lowering the strike tubes second ends (38, 58) in relation to the strike tubes first ends (36, 56). This raising or lowering is accomplished through manipulation of the elevation adjustment(s) 14. In the embodiment shown, the elevation adjustment 14 shown comprises a threaded portion 16 able to be tightened or loosened into or out of a frame receiver 15, thereby drawing the threaded portion 16 of the frame nearer or farther from said frame receiver 15. This results in the raising or lowering of the first ends 36, 56, thereby creating a crown or a trough in the screeded concrete due to the orientation of the second ends 38, 58 to one another. While this particular type of elevation adjustment is expressly disclosed as preferred, all other manners of elevation adjustment shown in the prior art are likewise included in this disclosure, as well as future manners of adjusting, including but not limited to screws, motors, engines, hydraulics, spacers, linkages, chains, cables, clamps, etc. A pinhole 17 for receiving a pin (not shown) is also preferably provided for allowing the threaded portion to be locked in place, inhibiting further rotation of the threaded portion.

The embodiment shown (FIG. 2) utilizes an articulating spline 20 for rotationally joining the strike tubes 40, 60 together. The use of cylindrical splines is shown in the prior art, however the invented spline 20 differs from the prior art splines in shape.

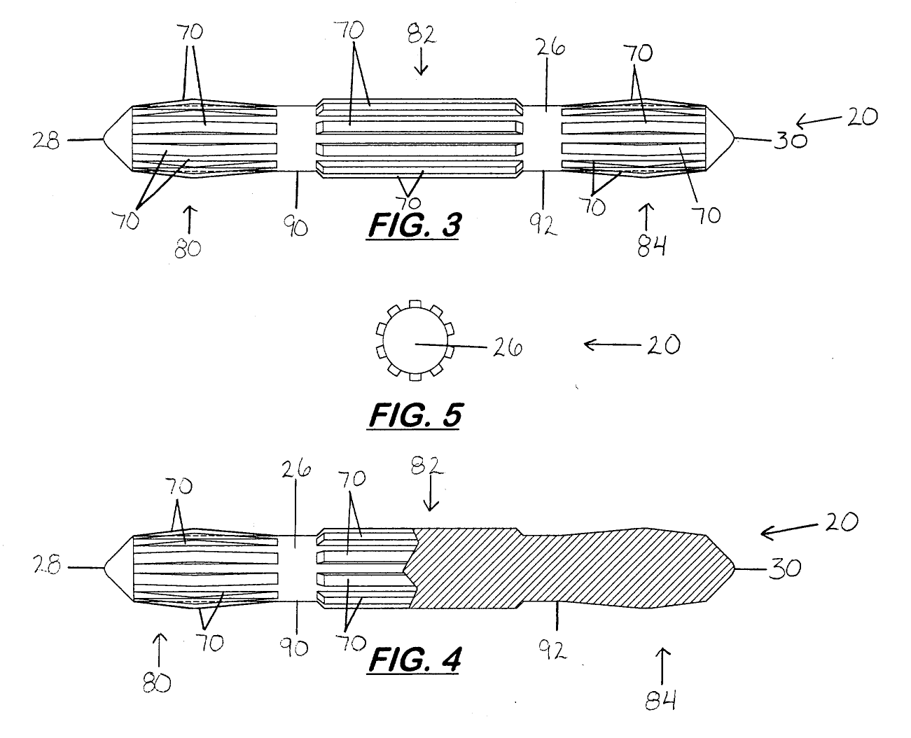

The invented spline 20 is particularly shown in FIGS. 3-5. Referring now to FIGS. 3-5, the spline comprises an elongated shaft 26 having a first end 28 extending to a second end 30. The shaft 26 defining a first portion 80, a central portion 82, and a second portion 84. A first annular groove 90 is defined in said shaft 26 between said central portion 82 and said first portion 80. This first portion 80 preferably being generally prolate (cigar-shaped) in shape between the first end 28 and the first annular groove 90. A second annular groove 92 is defined in said shaft 26 between said central portion 82, and said second portion 84. This second portion 84 preferably being generally prolate in shape between the second end 30 and the second annular groove 92.

It is preferred that a plurality of longitudinal gear teeth 70 on the spline first portion 80 for interfitting relationship with corresponding longitudinal gear teeth within the first strike tube coupling 46 (shown in FIG. 2) of the first strike tube (roller) 40. Likewise, it is preferred that a plurality of longitudinal gear teeth 70 on the spline second portion 84 for interfitting relationship with corresponding longitudinal gear teeth within the second strike tube coupling 66 (shown in FIG. 2) of the second strike tube (roller) 60.

This “prolate” shape could be further described as a first portion having a circumvolving first crest between the first annular groove and the first end. This first crest having a diameter greater than the first annular groove and greater than the first end, wherein the first portion circumvolvingly tapers from the first annular grove to the first crest and the first portion circumvolvingly tapers from the first crest to the first end. Likewise, the second portion having a circumvolving second crest between the second annular groove and the second end. The second crest having a diameter greater than the second annular groove and greater than the second end, wherein the second portion circumvolvingly tapers from the second annular grove to the second crest and the second portion circumvolvingly tapers from the second crest to the second end.

While the present invention is described and shown in the figures as having a spline that is symmetrical, this is not intended as a limitation. A roller screed could just as easily be provided with a spline having a standard cylindrical first end and a generally prolate second end, and other orientations and structures.

Referring back to FIG. 2, the spline 20 cooperates with a pair of bearing assemblies 18, 18′ that are mounted on the middle bracket 12. These bearings support the spline, which is rotationally mounted to the strike tubes. The first strike tube 40 having therein a first strike tube hub assembly 42 comprising a first strike tube hub 44 and a first strike tube coupling 46. The hub 44, connecting with said first strike tube 40, has a centered orifice defined therein for receiving said coupling. The coupling 46 mounted within and extending through the hub 44, this coupling having an interior portion that is configured with horizontal gear teeth configured to cooperate with the spline's gear teeth 70. The second strike tube 60 has therein a second strike tube hub assembly 62 comprising a second strike tube hub 64 and a second strike tube coupling 66. The hub 64 connects with said first strike tube 60, having a centered orifice defined therein for receiving said coupling. The coupling 66 is mounted within and extends through the hub 64. This coupling has an interior portion that is configured with horizontal gear teeth configured to cooperate with the spline's gear teeth 70.

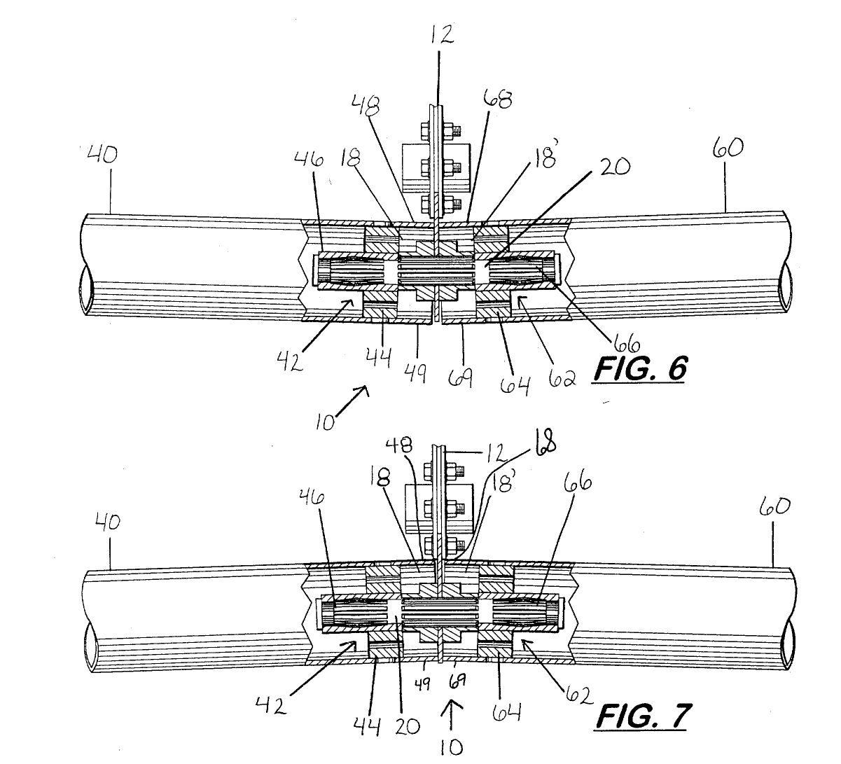

Referring now to FIG. 6, shown is the embodiment of FIG. 2 with the elevation adjustment causing the strike tubes first ends to be raised relative to the strike tubes second ends. The result is that the middle bracket 12 remains generally vertical, while the first ends are raised. This causes the top portions 48, 68 of the first and second strike tube second ends to be drawn closer together, with the bottom portions 49, 69 of the strike tube second ends drawn further apart, thereby providing for the creation of a trench within the concrete surface being screeded. Due to the prolate shape of the ends of the spline, the spline ends are allowed to generally rotate within the hubs, thereby causing no additional stress upon the junction caused by the elevation adjustment.

Referring now to FIG. 7, shown is the embodiment of FIG. 2 with the elevation adjustment causing the strike tubes first ends to be lowered relative to the strike tubes second ends. The result is that the middle bracket 12 remains generally vertical, while the first ends are lowered. This causes the top portions 48, 68 of the first and second strike tube second ends to be pushed further apart, with the bottom portions 49, 69 of the strike tube second ends drawn closer together, thereby providing for the creation of a crest or ridge within the concrete surface being screeded. Due to the prolate shape of the ends of the spline, the spline ends are allowed to generally rotate within the hubs, thereby causing no additional stress upon the junction caused by the elevation adjustment.

Thus, one embodiment of the present invention comprises a spline having one end generally prolate in shape. Another embodiment of the present invention comprises a spline having two generally prolate shaped ends. Another embodiment of the present invention comprises an improved screed utilizing the present invention. Another embodiment of the present invention is a novel manner of connecting two rotating parts. Other embodiments of the present invention are disclosed, explicitly or implicitly.

While there is shown and described the present preferred embodiment of the invention, it is to be distinctly understood that this invention is not limited thereto but may be variously embodied to practice within the scope of the following claims. From the foregoing description, it will be apparent that various changes may be made without departing from the spirit and scope of the invention as defined by the following claims.

I claim:

1. An articulating rotary spline for joining a first roller to a second roller so that rotation of the first roller or the second roller results in rotation of other roller, said spline comprising:
an elongated shaft having a first end extending to a second end;
said shaft defining a first portion, a central portion and second portion;
a first annular groove defined in said shaft between said central portion and said first portion;
said first portion generally prolate in shape between said first end and said first annular groove;
longitudinal gear teeth on said spline first portion for interfitting relationship with corresponding longitudinal gear teeth within said first roller; and,
longitudinal gear teeth on said spline second portion for interfitting relationship with corresponding longitudinal gear teeth within said second roller.

2. An articulating rotary spline for joining a first roller to a second roller so that rotation of the first roller or the second roller results in rotation of other roller, said spline comprising:
an elongated shaft having a first end extending to a second end;
said shaft defining a first portion, a central portion and second portion;
a first annular groove defined in said shaft between said central portion and said first portion;
a second annular groove defined in said shaft between said central portion and said second portion;
said first portion generally prolate in shape between said first end and said first annular groove;
said second portion generally prolate in shape between said second end and said second annular groove;
longitudinal gear teeth on said spline first portion for interfitting relationship with corresponding longitudinal gear teeth within said first roller; and,
longitudinal gear teeth on said spline second portion for interfitting relationship with corresponding longitudinal gear teeth within said second roller.

3. An articulating rotary spline for joining a first roller to a second roller so that rotation of the first roller or the second roller results in rotation of other roller, said spline comprising:
an elongated shaft having a first end extending to a second end;
said shaft defining a first portion, a central portion and second portion;
a first annular groove defined in said shaft between said central portion and said first portion;
a second annular groove defined in said shaft between said central portion and said second portion;
said first portion having a circumvolving first crest between said first annular groove and said first end, said first crest having a diameter greater than said first annular groove, said first crest having a diameter greater than said first end, wherein said first portion circumvolvingly tapers from said first annular grove to said first crest and said first portion circumvolvingly tapers from said first crest to said first end;
said second portion having a circumvolving second crest between said second annular groove and said second end, said second crest having a diameter greater than said second annular groove, said second crest having a diameter greater than said second end, wherein said second portion circumvolvingly tapers from said second annular grove to said second crest and said second portion circumvolvingly tapers from said second crest to said second end;
longitudinal gear teeth on said spline first portion for interfitting relationship with corresponding longitudinal gear teeth within said first roller; and,
longitudinal gear teeth on said spline second portion for intermitting relationship with corresponding longitudinal gear teeth within said second roller.
